(19) United States
(12) Patent Application Publication
(10) Pub. No.: US 2005/0065784 A1
(43) Pub. Date: Mar. 24, 2005

(54) Modification of acoustic signals using sinusoidal analysis and synthesis

(76) Inventors: Robert J. McAulay, Lexington, MA (US); Robert A. Baxter, Bedford, MA (US); Youngmoo E. Kim, Boston, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/903,908

(22) Filed: Jul. 30, 2004

Related U.S. Application Data
(60) Provisional application No. 60/491,495, filed on Jul. 31, 2003.
(60) Provisional application No. 60/512,333, filed on Oct. 17, 2003.

(51) Int. Cl. G10L 19/14; G10L 13/04

(52) U.S. Cl. 704/205

(57) ABSTRACT

An analysis and synthesis system for sound is provided that can independently modify characteristics of audio signals such as pitch, duration, and timbre. High-quality pitch-scaling and time-scaling are achieved by using a technique for sinusoidal phase compensation adapted to a sinusoidal representation. Such signal modification systems can avoid the usual problems associated with interpolation-based re-sampling so that the pitch-scaling factor and the time-scaling factor can be varied independently, arbitrarily, and continuously. In the context of voice modification, the sinusoidal representation provides a means with which to separate the acoustic contributions of the vocal excitation and the vocal tract, which can enable independent timbre modification of the voice by altering only the vocal tract contributions. The system can be applied to efficiently encode the pitch in sinusoidal models by compensating for pitch quantization errors. The system can also be applied to non-speech signals such as music.

### RELATED APPLICATIONS

This application claims the benefit of U.S. Provisional Application No. 60/491,495, filed Jul. 31, 2003 and U.S. Provisional Application No. 60/512,333, filed Oct. 17, 2003. The entire teachings of the above applications are incorporated herein by reference.

### BACKGROUND OF THE INVENTION

There are many well-documented techniques for the pitch- and time-modification of sampled acoustic signals, in particular speech. Many of these techniques are based on the re-sampling of signals, which is akin to playback of a sampled waveform at a rate different than that at which it was originally sampled. For example, playing at a higher sampling rate will result in a higher pitch, but will also compress the time duration of the waveform. Conversely, playing at a lower sampling rate will result in a lowering of pitch and an increase of overall duration. Since independent control of pitch and duration is more desirable, some systems utilize time-domain replication or excision of some portion(s) of the original waveform in order to expand or contract the duration of the signal, a process called time-scaling.

Re-sampling is a straightforward approach to the pitch- and time-modification of speech because the re-sampling operation inherently changes the pitch in a way that maintains the correct phase and frequency relationship of the underlying frequency components of the speech. However, since it compresses (or expands) the duration of the speech, an undesirable effect is the change in rate of vocal tract articulation. This effect must then be corrected by time-scaling the re-sampled waveform. Additionally, the re-sampling operation, while correctly shifting the frequencies and phases, also shifts the spectral shape, an effect that is maintained during the corrective time-scaling operation. When performed in the time-domain, re-sampling via interpolation can be difficult to implement, particularly for arbitrary and time-varying values of the pitch scale factor. Conversely, if frequency-domain re-sampling is used, approximations used in the interpolation step can introduce aliasing.

Pitch-scaling and time-scaling techniques can also be applied in the frequency domain. Systems based on the Short-Time Fourier Transform (STFT), also known as the phase vocoder, have been used for this application. Phase discontinuity of the modified signals in these systems remains a problem, and the quality of modified sounds may suffer as a result, possessing excessive reverberance. Thus, there exists the need for a modification framework which not only leverages the strengths of the sinusoidal model, but also ensures continuity of phase relationships when pitch-scaling or time-scaling operations are performed.

Modification may also involve altering the “color” or “character” of the acoustic signal, called timbre modification. The term ‘timbre’ refers to the collection of acoustic attributes that differ between two signals having the same pitch and loudness. Prior work in the modification of speech timbre has focused on the limited alteration of the spectral envelope, thus affecting individual frequency amplitudes. The spectral envelope is also closely related to the phoneme, and too much alteration may lead to a different phoneme altogether. This is undesirable for most speech applications, where the intent is to preserve the spoken content while altering the color of the speech or obscuring the identity of the speaker. Spectral envelope modification has also been used to restore the original timbre of speech that has been degraded due to time- or pitch-scaling.

Previous implementations of the sinusoidal representation for acoustic waveforms have allowed for the modification of pitch and timbre using only the measured amplitudes of the component frequencies. These systems discard the measured phase information and impose a set of synthetic phases based on an assumed model. The synthetic phases, however, do not always accurately reflect the true phases of the acoustic signal resulting in a loss of perceived sound quality.

### SUMMARY OF THE INVENTION

The present invention addresses the quality deficiencies of prior sinusoidal analysis and synthesis systems for signal modification by allowing independent pitch, time, and timbre manipulation using a sinusoidal representation with measured amplitudes, frequencies, and phases. When applied to speech signals, the use and proper manipulation of measured phases results in more realistic modified speech.

In a preferred embodiment, signals are represented using a sinusoidal analysis and synthesis system, from which a model of the pitch-scaled waveform is derived. Time-scaling (for time correction or modification) is then achieved by applying the sinusoidal-based time-scale modification algorithm directly to the sine-wave representation of the pitch-scaled waveform coupled with a novel technique for phase compensation that provides phase coherence for continuity of the modified signal. By applying an inverse filter to the measured sine wave amplitudes and phases, it becomes possible to alter the vocal tract shape and alter voice-quality independent of the pitch-scaling and time-scaling operations. The sinusoidal representation also avoids the shortfalls of time-domain and frequency-domain re-sampling, allowing for arbitrary pitch-scaling and time-scaling values without the distortion of aliasing.

According to one embodiment, the present invention provides a system and method of pitch-scaling an acoustic waveform independent of time-scaling and timbre modification of the original waveform, if any. Such modification of an acoustic waveform can include (i) sampling an original waveform to obtain a series of discrete samples and constructing therefrom a series of frames, each frame spanning a plurality of samples; (ii) analyzing each frame of samples to obtain a set of components having individual amplitudes, frequencies, and phases which, in summation, approximate the waveform of the frame, the set of components being characterized by a fundamental frequency; (iii) modifying the individual frequencies of the set of components by a pitch-scaling factor, resulting in a set of modified components having individual pitch scaled frequencies that are characterized by a pitch-scaled fundamental frequency; and (iv) for each of the individual phases of the set of modified components, adding a phase compensation term that depends on the fundamental frequency and the pitch-scaled fundamental frequency, the phase compensation term enabling a synthesized pitch-scaled waveform to be generated having frames sizes that are substantially equal to the frame sizes of the original waveform and having phase coherence across frame boundaries. The phase compensation term can be a linear term that is proportional to the pitch scaled frequencies. The proportion preferably depends on a difference between a first onset time associated with the original waveform and a second onset time associated with the pitch-scaled synthesized waveform.

The pitch-scaling factor can be continuously variable over a defined range and the set of components can includes any set of sinusoidal functions with finite support in the time domain or any set of sinusoidal functions with infinite support in the time domain. A synthesized pitch-scaled waveform can be generated from the set of modified components for each frame.

According to another embodiment, the present invention provides a system and method of pitch-scaling and time-scaling an acoustic waveform. In such embodiments, the acoustic waveform is further modified by independently modifying a frame size of a synthesis frame containing the set of modified components by a time-scaling factor. The time-scaling factor can be continuously variable over a defined range. The phase compensation term that is added to the individual phases is further dependent on the time-scaling factor with the phase compensation term, enabling a synthesized pitch-scaled and time-scaled waveform to be generated having frame sizes that differ from the frame sizes of the original waveform and having phase coherence across frame boundaries. The phase compensation term is preferably a linear phase term that is proportional to the pitch scaled frequencies, the proportion depending on a difference in a first onset time associated with the pitch-scaling factor and a second onset time associated with the time-scaling factor.

According to another embodiment, the present invention provides a system and method of pitch-scaling and timbre-modification of an acoustic waveform. In such embodiments, the acoustic waveform is further modified by independently modifying the individual amplitudes and phases of the set of modified components to warp the spectral envelope of the waveform, enabling a synthesized pitch-scaled and timbre-modified waveform to be generated. The spectral enveloped of the acoustic waveform can be warped by (i) estimating an amplitude of the spectral envelope; (ii) applying a linear or nonlinear mapping from the estimated spectral envelope amplitude to the warped spectral envelope; and (iii) estimating the phase of the spectral envelope using a minimum phase assumption. Signal modification may also involve independent application of time-scaling and timbre modification together with pitch-scaling of the acoustic waveform.

The present invention can be utilized in a number of applications. For example, embodiments of the invention can be applied to efficiently encode the pitch in sinusoidal models. In typical sinusoidal coders, the pitch and phases are quantized independently. This requires that the pitch quantization error be very small in order to maintain phase coherence which may require an excessive number of bits. However, in a preferred embodiment, the phase coherence is maintained by pitch shifting by an amount corresponding to the pitch quantization error. In other words, the individual frequencies of the set of components are modified by a pitch scaling factor to compensate for quantization errors introduced by pitch quantization. This process will maintain phase coherence and allow for the use of fewer bits for quantizing the pitch.

In another example, embodiments of the invention can be applied to code or compress acoustic signals, particularly speech and music signals. In coding or compression applications, the sinusoidal model parameters are quantized, encoded, and packed into a bit stream. The bit stream can be decoded by unpacking, decoding, and unquantizing the parameters. Specifically, the set of components from each frame of the original waveform or the set of modified components can be further coded or compressed prior to generation of the synthesized waveform. Alternatively, the set of components from each frame of the original waveform or the set of modified components can be decoded or decompressed prior to generation of the synthesized waveform.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is the overall decision-flow diagram of the sinusoidal analysis and synthesis system for signal modification according to one embodiment.

FIG. 2 is an overall block diagram of a sinusoidal analysis and synthesis system for signal modification according to one embodiment.

FIG. 3 is a detailed block diagram of the analysis procedure, which is used to extract sinusoidal parameters required for signal modification according to one embodiment.

FIG. 4 is a detailed block diagram of a phase compensation stage according to one embodiment.

FIG. 5 is a detailed block diagram of the synthesis procedure, required for regenerating the time- and pitch-scaled waveform according to one embodiment.

FIG. 6 is a general illustration showing one frame of sampled speech (20 ms duration).

FIG. 7 is a general illustration of the sinusoidal parameters using a time-domain representation of a signal.

FIG. 8 illustrates sinusoidal analysis in the frequency-domain, which is used for estimation of frequency, magnitude, and phase parameters according to one embodiment.

FIG. 9 illustrates the representation of a signal as a number of sinusoids, using the frequency, magnitude, and phase parameters measured using the sinusoidal analysis of FIG. 8.

FIG. 10 illustrates the effect of re-sampling and time-scaling in the time-domain with and without phase compensation according to one embodiment.

FIG. 11 shows steps involved in timbre modification using spectral envelope estimation and warping, according to one embodiment.

### DETAILED DESCRIPTION OF THE INVENTION

A description of preferred embodiments of the invention follows.

The present invention provides a system and method of modifying an acoustic waveform. In the preferred embodiments, the system and method generates a synthesized pitch-scaled version of an original acoustic waveform independent of time-scaling and timbre modification of the original waveform, if any.

In the following sections, the basic sinusoidal analysis and synthesis system is reviewed, and a representation suitable for the modification of acoustic waveforms is developed. Afterwards, the equations for sinusoidal-model-based time scaling and pitch scaling are derived. A scheme to ensure phase coherence across frame boundaries in a modified model is also derived. These modification techniques are typically applied to a speech signal, but they also apply to non-speech audio signals. A technique for correction and modification of timbre via manipulation of model parameters is also specified.

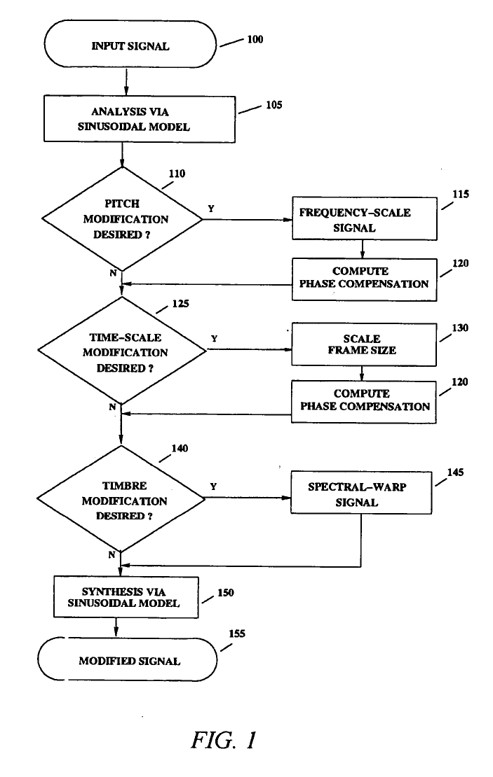

FIG. 1 is the overall decision-flow diagram of the sinusoidal analysis and synthesis system for signal modification according to one embodiment. The system receives an input signal 100 that is passed to the sinusoidal analysis unit 105. Three types of signal modification can be applied independently. Depending on the state of the pitch modification switch 110, the signal is either passed to a frequency-scaling unit 115 and a phase compensation computation unit 120, or passed directly to the time-scale modification switch 125. If time-modification is desired, the signal is passed to a frame size scaling unit 130 and phase compensation computation unit 120. Otherwise, the signal is passed directly to the timbre modification switch 140. If timbre modification is chosen, the signal is passed to a spectral warping unit 145 before the sinusoidal synthesis unit 150. The overall system output is the modified signal 155.

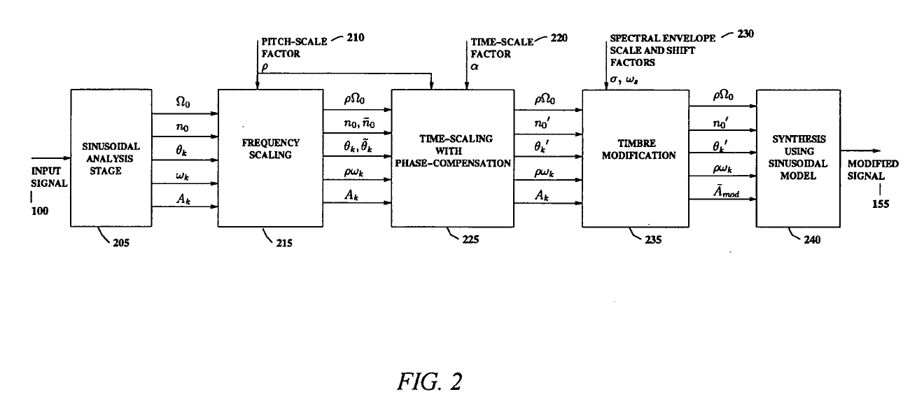

FIG. 2 is an overall block diagram of the sinusoidal analysis and synthesis system for signal modification according to one embodiment. The input signal 100 is used by the sinusoidal analysis unit 205 to generate the model parameters. The parameters are used by the frequency scaling unit 215, which also takes a pitch-scaling factor 210 as input, to produce frequency-scaled parameters. These frequency-scaled parameters are used as input to the time-scaling and phase-compensation unit 225, which also takes the time-scale factor 220 as input, resulting in time-scaled and frequency-scaled model parameters. These are input to the timbre modification unit 235, which also uses spectral envelope factors 230 to produce the final modified model parameters. The modified output signal 155 is generated by the sinusoidal synthesis unit 240 from the modified model parameters.

The Sinusoidal Model

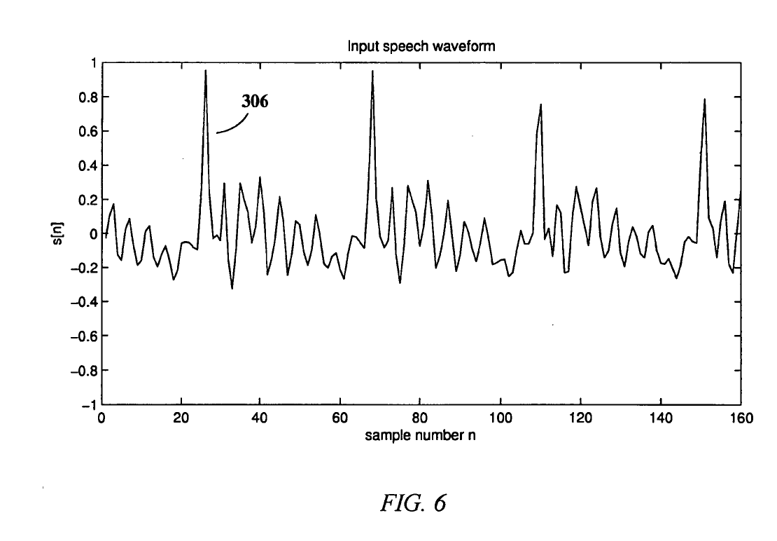

FIG. 6 is a general illustration showing one frame of sampled speech (20 ms duration). A short-duration segment of a speech waveform, e.g. the signal 306 depicted in FIG. 6, can be modeled as a sum of sinusoidal components as

$$s ( t ) = Re 〈 {\sum }_{k = 1}^{K ( m )} {A}_{k}^{m} exp \{ j ( ( t - mT ) {ω}_{k}^{m} + {θ}_{k}^{m} ) \} 〉 \qquad ( 1 )$$

where {Aₖ^{m}, ωₖ^{m}, θₖ^{m}} are, respectively, the real-valued amplitudes, frequencies, and phases of the kth sinusoidal component in the mth segment. Here, the Re(.) operator refers to the real portion of the complex signal. The short-duration segments are commonly referred to as frames. An embodiment of a sinusoidal analysis and synthesis system that models speech waveform as a sum of sinusoidal components is described in (i) R. J. McAulay and T. F. Quatieri, “Speech Analysis-Synthesis Based on a Sinusoidal Representation”, in IEEE Trans. Acoustics, Speech and Signal Processing, ASSP-34, (4), 1986, pp. 744-754 (hereinafter “McAulay(1)”) and (ii) R. J. McAulay and T. F. Quatieri, “Phase Modelling and Its Application to Sinusoidal Transform Coding”, Proc, IEEE Int. Conf. Acoust., Speech and Signal Processing, Tokyo, Japan, Apr. 7-11, 1986, pp. 1713-1715 (hereinafter “McAulay(2)”), the entire contents of which are incorporated herein by reference.

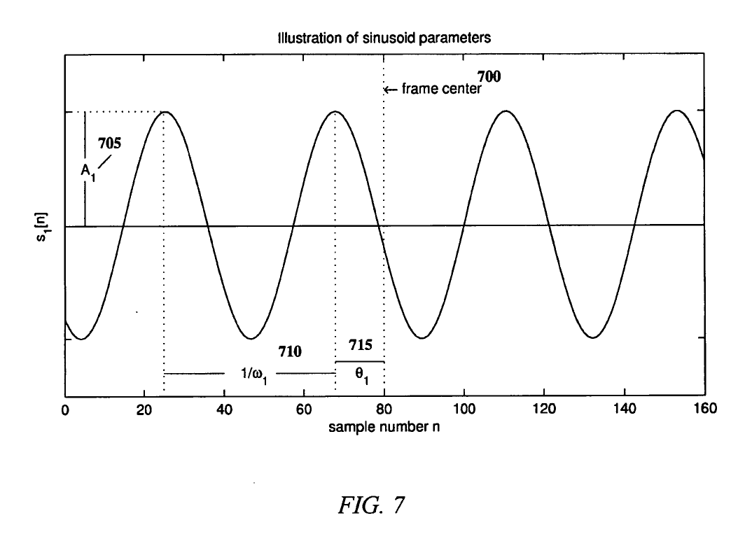

FIG. 7 is a general illustration of the sinusoidal parameters-using a time-domain representation of a signal. Specifically, FIG. 7 illustrates the individual parameters, amplitude A₁ 705, period 710 (the reciprocal of frequency ω₁), and phase θ₁ 715, of a single sinusoid in the time domain. The phase is in reference to the frame center 700.

The model of Eq. 1 is used to synthesize waveforms of arbitrary duration by applying the model to each frame, using K(m) sinusoidal components for frame m, and ensuring the model parameters are consistent and properly interpolated across adjacent frames. The preferred embodiment employs the overlap-add method of interpolating across adjacent frames, in which case the model of Eq. 1 spans the fixed time interval
(m−1)T≦t≦(m+1)T. (2)

Here, m is the frame number, T is the frame length, and 1/T is the frame rate. Thus, T seconds of data are synthesized per frame. In alternative embodiments, the time interval spanned by the model can take on different lengths and change from frame to frame. In addition, other interpolation techniques could be used, such as frequency matching and amplitude and phase interpolation.

Also, although the component functions of the model of Eq. 1 have infinite support in the time domain, in alternative embodiments the component functions may have finite support in the time domain. To enforce finite support in the time domain, and to allow the support to vary from frame to frame, a window, wₖ^{m}(t), can be applied to each sinusoidal component. A limited class of such windows exists that permit a straightforward extension to the model of Eq. 1. One such window consists of a flat region that spans several frames and is centered on the center of the synthesis frame and decays slowly to zero away from the flat region. Alternative embodiments include models in which the component functions are of finite but variable extent and the model is allowed to span a variable time interval from frame to frame. This generalized model can be written as

$$s ( t ) = Re 〈 {\sum }_{k = 1}^{K ( m )} {A}_{k}^{m} exp \{ j [ ( t - {t}_{m} ) {ω}_{k}^{m} + {θ}_{k}^{m} ] \} {w}_{k}^{m} ( t ) 〉 \qquad ( 3 )$$

where tₘ is the center of frame m. To simply the notation, the Re(·) operator and the window are dropped hereafter. For the following discussion, the time interval spanned by the model is fixed at T and the window is unity for all t.
Analysis Stage

The model parameters include the number of components and the amplitudes, frequencies, and phases of each component. The model parameters are extracted in the analysis unit 205. For example, in order to extract these parameters, the waveform is broken down into short-duration segments which are referred to as analysis frames and which are distinct from but aligned with the synthesis frames. The synthesis frame lengths are the time intervals spanned by the model. In the preferred embodiment, the analysis frames are permitted to have variable length from frame to frame and the length of the synthesis frames is fixed, but the centers of the analysis and synthesis frames are aligned. With time-scaling, however, the length of the synthesis frames may vary according to the time-scaling factor. Alternative embodiments exist in which the beginnings or ends of the analysis and synthesis frames are used for frame alignment.

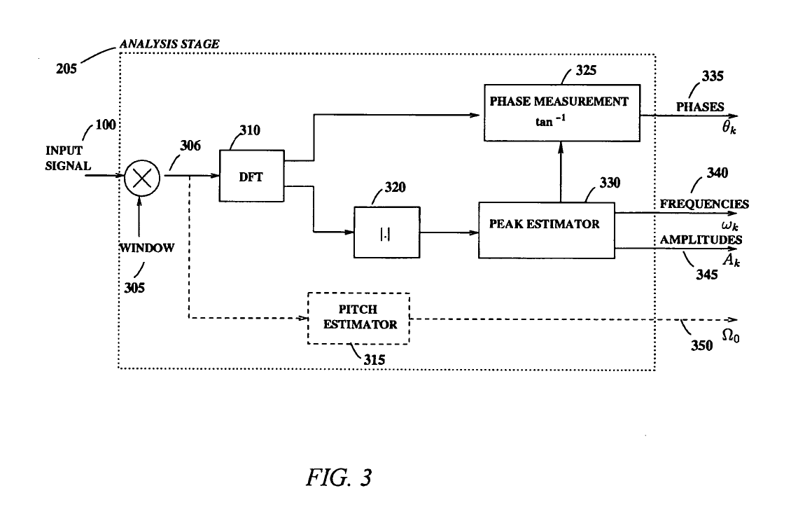

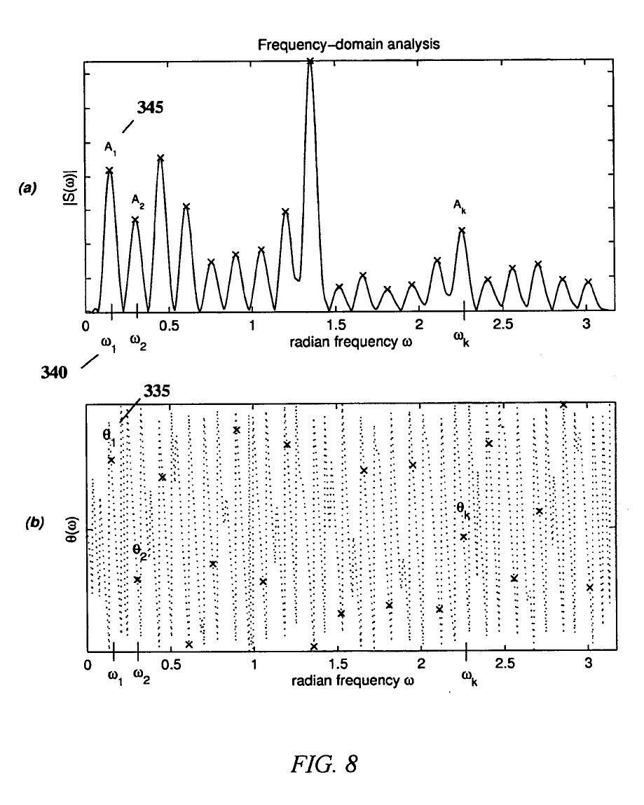

FIG. 3 is a detailed block diagram of the analysis procedure, which is used to extract sinusoidal parameters required for signal modification according to one embodiment. In this embodiment, the amplitudes and frequencies of the underlying sinusoidal components, {Aₖ^{m} 345, ωₖ^{m} 340}, are obtained by finding the peaks of the magnitude of the Short-Time Fourier Transform (STFT). As is standard practice, the STFT applies a window 305 to the input signal 100 to create a short-time windowed signal 306. The Discrete Fourier Transform (DFT) 310 is then used to compute the spectral coefficients. The preferred embodiment employs a Hamming window, but any finite support window function can be used. The preferred embodiment uses a pitch-adaptive analysis window size in which the window length is approximately two and one-half times the average pitch period. This condition ensures that there will be well-resolved sine waves for low-pitched sounds. The output of the DFT is passed through a magnitude function 320, resulting in the magnitude of the spectrum. The peaks of the STFT are local maxima 345 in the spectrum that, in periodic signals, are associated with energy regions related to the harmonic structure. In the preferred embodiment, the peak estimator unit 330 operates by finding the local peaks of the spectrum to determine amplitudes Aₖ^{m} 345 and corresponding frequencies ωₖ^{m} 340 of the windowed input signal. This process is depicted in the frequency domain of FIG. 8(a). Specifically, FIG. 8 illustrates sinusoidal analysis in the frequency-domain, which is used for estimation of frequency, magnitude, and phase parameters according to one embodiment.

In an alternate embodiment, a process called SEEVOC is used for peak estimation, which involves selecting one peak in each bin where the sizes of the bins are directly related to the fundamental frequency. For more information, refer to W. Zhang, H. S. Kim, and W. H. Holmes, “Investigation of the spectral envelope estimation vocoder and improved pitch estimation based on the sinusoidal speech model,” Proceedings of 1997 International Conference on Information, Communications and Signal Processing (ICICS), (1), 9-12 Sep. 1997, pp. 513-516, the entire contents of which are incorporated herein by reference.

Additional alternative embodiments employ other methods of peak-picking including thresholding an estimated spectral envelope, filter-bank analysis, or combinations thereof. Any peak picking technique should be robust enough to discard spurious peaks caused by the window function or noise. Methods other than peak picking can also be used to estimate the sinusoidal components, such as least-squares iterative methods. For more information, refer to E. B. George and M. J. T. Smith. “Speech Analysis/Synthesis and Modification Using an Analysis-by-Synthesis/Overlap-Add Sinusoidal Model”. IEEE Transactions on Speech and Audio Processing 5(5), 1997, pp. 389-406, the entire contents of which are incorporated herein by reference.

Referring back to FIG. 3, once the frequencies ωₖ^{m} 340 corresponding to the model amplitudes Aₖ^{m} 345 are estimated, the phase measurement unit 325 determines the corresponding phases θₖ^{m} 335. In the preferred embodiment, the phases corresponding to each frequency are estimated from the real and imaginary parts of the STFT at frequencies ωₖ^{m}. In alternative embodiments, the phases can be estimated using other means such as iterative searching or determining phase deviations from known or assumed phase relationships. The measurement of phases θₖ^{m} 335 from the phase of the STFT is illustrated in FIG. 8(b).

Synthesis Stage

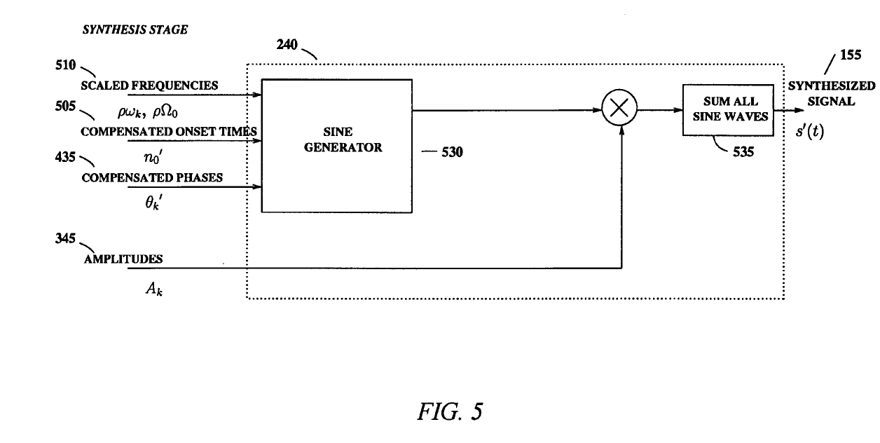

FIG. 5 is a detailed block diagram of the synthesis procedure, required for regenerating the time- and pitch-scaled waveform according to one embodiment. After estimating the sinusoidal model parameters in the analysis stage the parameters are modified as desired, and the modified waveform is synthesized by the sinusoidal synthesis unit 240. The modified frequencies 510, phases 435, and onset times 505 for each frame are passed to the sine generator unit 530, which outputs a corresponding frame of sinusoids. These sinusoids are then scaled by amplitudes 345. The scaled sine waves are passed to the summation unit 535, resulting in individual frames of the synthesized signal 155.

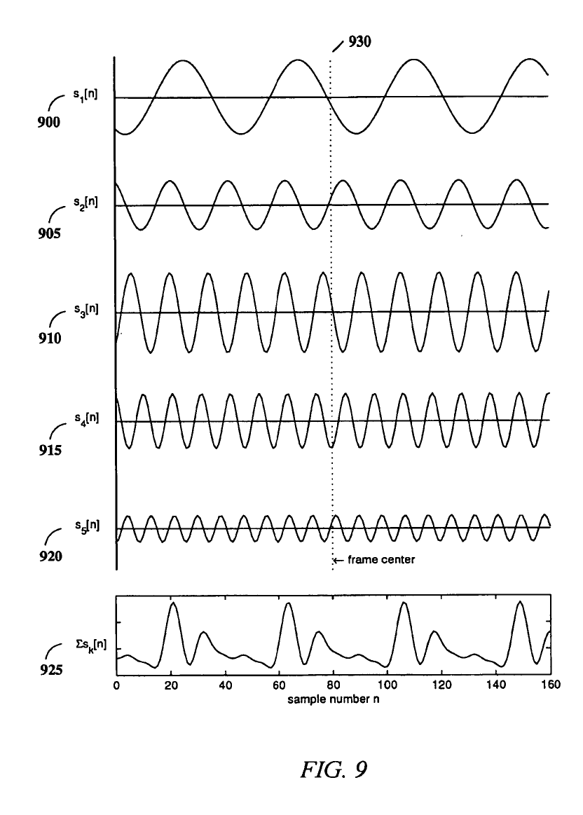

FIG. 9 illustrates the representation of a signal as a number of sinusoids, using the frequency, magnitude, and phase parameters measured using the sinusoidal analysis of FIG. 8. Specifically, FIG. 9 illustrates five scaled sinusoidal components 900, 905, 910, 915, and 920 as extracted from the example signal frame of FIG. 6. The summation of just these five sinusoids is shown in 925, which begins to approximate the example input frame, demonstrating how sinusoids are used to model acoustic signals.

In the preferred embodiment, the waveform is synthesized by applying overlap-add techniques to successive synthesis frames using the sinusoidal model and the extracted parameters. Alternative embodiments may use contiguous frames and employ a parameter tracking and matching scheme to ensure signal continuity from frame-to-frame. The model parameters must be estimated sufficiently often in order to synthesize a waveform that is perceptually similar to the original. In the preferred embodiment, the centers of the synthesis frames are spaced approximately 10 ms apart. Alternative embodiments employ interpolation between successive frames to increase the spacing between the frame centers and lower the complexity of the analysis stage while maintaining the quality of the synthesized waveform.

This sinusoidal model works equally well for reconstructing multi-speaker waveforms, music, speech in a musical background, marine biologic signals, and a variety of other audio signals. Furthermore, the reconstruction does not break down in the presence of noise. The synthesized noisy signal is perceptually similar to the original with no obvious modification of the noise characteristic.

Time-Scaling Using the Sinusoidal Model

A method of time scaling using a sinusoidal representation is described in McAulay(2) and R. J. McAulay and T. F. Quatieri, “Low Rate Speech Coding Based on the Sinusoidal Speech Model,” Chapter 6, Advances in Speech Signal Processing, S. Furui and M. M. Sondui, Eds., Marcel Dekker, New York, 1992 (hereinafter “McAulay(3)”), the entire contents of which are incorporated herein by reference. A different approach is used here.

In this section, the time-scaling operation is first developed for a periodic waveform. In this case the waveform can be generally represented as a sum of complex sinusoids:

$$p ( t ) = {\sum }_{k = 1}^{K ( m )} {A}_{k}^{m} exp \{ j [ ( t - mT ) {ω}_{k}^{m} + {θ}_{k}^{m} ] \} , \qquad ( 4 )$$

where Aₖ^{m} 345, ωₖ^{m} 340, and θₖ^{m} 335 are the amplitudes, frequencies, and phases, respectively, of the K(m) harmonic components for frame m. Since the waveform is periodic, all of the component frequencies are integer multiples of a fundamental frequency

$${Ω}_{0}^{m} = \frac{2 π}{{τ}_{0}^{m}} , \qquad ( 5 )$$

where the fundamental frequency Ω₀^{m} 350 is expressed in radians/sec and τ₀^{m} is the pitch period in seconds. Now, Eq. 4 can be re-written in terms of the fundamental frequency:

$$p ( t ) = {\sum }_{k = 1}^{K ( m )} {A}_{k}^{m} exp \{ j [ ( t - mT - {n}_{0}^{m} ) k {Ω}_{0}^{m} + {Φ}_{k}^{m} ] \} \qquad ( 6 )$$

where n₀^{m} 431 is the onset time for the current frame. The onset time determines the time at which all of the component excitation sinusoids come into phase, a property referred to as phase coherence. For more information regarding phase coherence of excitation sinusoids refer to McAulay(2) and (3). This property is preferably maintained under the time-scaling operation. Otherwise the sine waves are not strongly correlated one to another resulting in a reverberant quality to the sound.

Note that the component phases at all harmonic frequencies are now represented in two parts:
θₖ^{m}=kθ₀^{m}+Φₖ^{m} (7)
where
θ₀^{m}=−n₀^{m}Ω₀^{m} (8)
Eq. 8 represents the phase of the fundamental frequency, or fundamental phase, determined by the fundamental frequency and onset time of the periodic waveform. In Eq. 7, the term kθ₀ represents the linear phase component, which is a contribution of the fundamental frequency (or pitch), Ω₀^{m}. The second term, Φₖ^{m}, is the phase offset as measured from the linear phase component. This separation of phases provides a convenient way to specify and maintain phase coherence, which is necessary for high-quality time-scale modification. In other words, it is now possible to maintain the pitch-related linear phase component inherent in the glottal excitation under the time-scaling operation. It may be emphasized that the measured phases of the harmonics, θₖ^{m}, consist of the sum of the linear phase and offset phases.
Maintaining Phase Coherence Under Time-Scaling

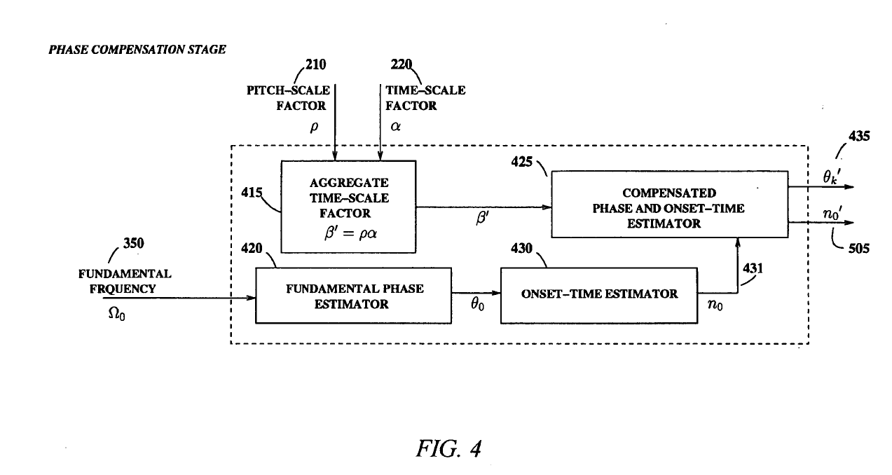

FIG. 4 is a detailed block diagram of a phase compensation stage according to one embodiment. Specifically, FIG. 4 depicts the phase compensation unit 120 (225 with time-scaling). An alternate representation for Eq. 8 is to write it as

$$p ( t ) = {\sum }_{k = 1}^{K ( m )} {A}_{k}^{m} exp \{ j [ ( t - mT ) k {Ω}_{0}^{m} + k {θ}_{0}^{m} + {Φ}_{k}^{m} ] \} , \qquad ( 9 )$$

which is obtained by substituting the fundamental phase of Eq. 8. Since the fundamental phase is the integral of the instantaneous pitch frequency, and since over short-duration segments the phase is approximately linear, the fundamental phase estimation unit 420 operates by applying linear interpolation of the pitch frequencies from frame-to-frame:

$${θ}_{0}^{m} = {θ}_{0}^{m - 1} + {\int }_{( m - 1 ) T}^{mT} {Ω}_{0}^{m} ( t ) ⅆ t \approx {θ}_{0}^{m - 1} + ( {Ω}_{0}^{m - 1} + {Ω}_{0}^{m} ) \frac{T}{2} . \qquad ( 10 )$$

By simply rearranging the terms of Eq. 8, the onset time nₖ^{m} 431 for frame m can now be calculated from the fundamental phase and the fundamental frequency as
n₀^{m}=−θ₀^{m}/Ω₀^{m}. (11)

This function is performed by the onset-time measurement unit 430.

To time scale this waveform means to change the rate of articulation of the amplitude and phase of the “vocal tract” while maintaining the pitch of the excitation and the property of phase coherence. If a frame of length T is mapped into a frame of length \hat{T} 1020:
\hat{T}=βT, (12)
where β is the time-scaling factor, then the time-scaled waveform for frame m is given by

$$\hat{p} ( t ) = {\sum }_{k = 1}^{K ( m )} {A}_{k}^{m} exp \{ j [ ( t - m \hat{T} ) k {Ω}_{0}^{m} + k {\hat{θ}}_{0}^{m} + {Φ}_{k}^{m} ] \} , \qquad ( 13 )$$

where, as in Eq. 10, the time-scaled fundamental phase can be estimated as

$${\hat{θ}}_{0}^{m} \approx {\hat{θ}}_{0}^{m - 1} + ( {Ω}_{0}^{m - 1} + {Ω}_{0}^{m} ) \frac{\hat{T}}{2} . \qquad ( 14 )$$

The time-scaled periodic waveform of Eq. 13 now applies over the range
(m−1)\hat{T}≦t≦(m+1)\hat{T}. (15)
After time-scaling, the compensated onset time relative to the center of the time-scaled analysis frame \hat{n}₀^{m} 505 is now
\hat{n}₀^{m}=−\hat{θ}₀^{m}/Ω₀^{m}. (16)
The functions indicated in Eqs. 14 and 16 are performed by the phase compensation and onset-time estimator unit 425.

Rearranging Eq. 7 and substituting into Eq. 13, the time-scaled periodic signal can alternatively be written as

$$\hat{p} ( t ) = {\sum }_{k = 1}^{K ( m )} {A}_{k}^{m} exp \{ j [ ( t - m \hat{T} ) k {Ω}_{0}^{m} + ( {θ}_{k}^{m} - k {θ}_{0}^{m} ) + k {\hat{θ}}_{0}^{m} ] \} \qquad ( 17 )$$

In other words, the time-scaled waveform is obtained by removing from the measured phases the linear phase component computed relative to the center of the original frame and subsequently adding in the linear phase component computed relative to the center of the time-scaled frame. Substituting Eqs. 11 and 16 into Eq. 17, the time-scaled periodic waveform can be written in terms of the difference between the onset times as

$$\hat{p} ( t ) = {\sum }_{k = 1}^{K ( m )} {A}_{k}^{m} exp \{ j [ ( t - m \hat{T} ) k {Ω}_{0}^{m} + {θ}_{k}^{m} + ( {n}_{0}^{m} - {\hat{n}}_{0}^{m} ) k {Ω}_{0}^{m} ] \} \qquad ( 18 )$$

Although the mathematics for the above result was developed for waveforms having harmonic frequencies, this operation can also be applied to the more general case when the measured frequencies are not harmonic. For more information, refer to McAulay(2) and (3). In this case, the sinusoidal model

$$s ( t ) = {\sum }_{k = 1}^{K ( m )} {A}_{k}^{m} exp \{ j [ ( t - mT ) {ω}_{k}^{m} + {θ}_{k}^{m} ] \} \qquad ( 19 )$$

which after time-scaling can be written in terms of the onset times as

$$\hat{s} ( t ) = {\sum }_{k = 1}^{K ( m )} {A}_{k}^{m} exp \{ j [ ( t - m \hat{T} ) {ω}_{k}^{m} + {θ}_{k}^{m} + ( {n}_{0}^{m} - {\hat{n}}_{0}^{m} ) {ω}_{k}^{m} ] \} \qquad ( 20 )$$

which is valid over the range specified by Eq. 15 and where the onset times are computed using Eqs. 11, 14, and 16. As long as the extracted frequencies of the model are mostly harmonic, the onset time phase compensation will still maintain phase coherence under time-scaling, ensuring high sound quality. In the preferred embodiment, the fundamental frequencies Ω₀^{m} 350 are estimated by a pitch estimator unit 315 in order to obtain the onset times n₀^{m} 431.

In an alternative embodiment, the onset times are instead estimated by a set of pitch pulses. For more information, refer to (i) R. J. McAulay and T. F. Quatieri, “Sinusoidal Coding”, Chapter 4, Speech Coding and Synthesis, W. B. Kleijn and K. K. Paliwal, Eds, Elsevier Science B. V., New York, 1995 (hereinafter “McAulay(4)”) and (2) T. F. Quatieri and R. J. McAulay “Audio Signal Processing Based on a Sinusoidal Analysis/Synthesis System” Chapter 9, Applications of Digital signal Processing to Audio and Acoustics, M. Kahrs and K. Brandenburg, Eds, Kluwer Academic, Boston, 1998, the entire contents of which are incorporated herein by reference.

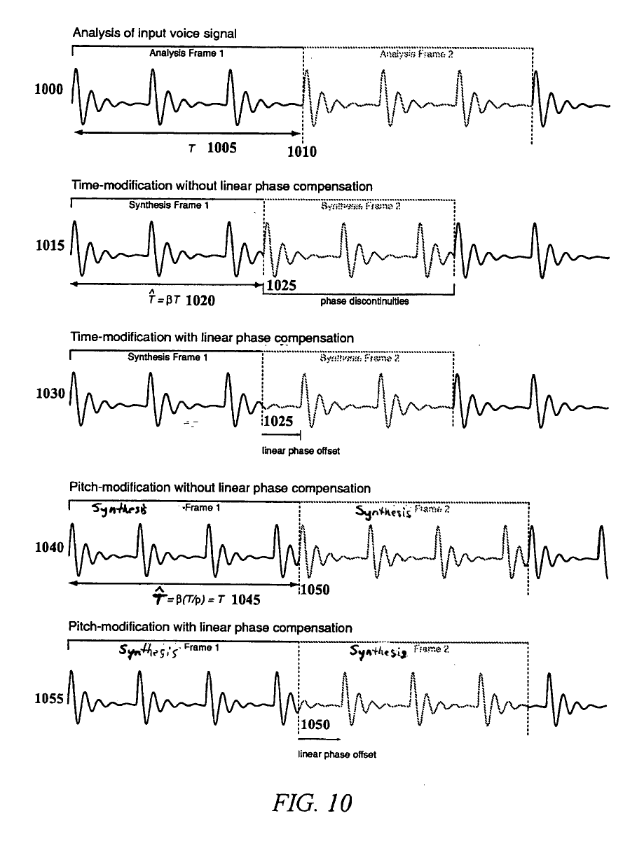

FIG. 10 illustrates the effect of pitch-scaling and time-scaling in the time-domain with and without phase compensation according to one embodiment. Specifically, FIG. 10 illustrates the importance of phase compensation in order to maintain phase coherence for time-scaling of signals. In the case of an example input signal 1000, the time-scaled signal 1015 represents frame-based time-scaling by factor \hat{T} 1020 without linear phase compensation resulting in a distorted signal. Notice the phase discontinuity at 1025. Conversely, signal 1030 depicts the same time-scale modification using the derived phase-compensation (i.e., linear phase offset 1025), eliminating the distortion.

The present invention provides a system and method of modifying an acoustic waveform such that a synthesized pitch-scaled version of an original acoustic waveform can be generated independent of time-scaling and timbre modification of the original waveform, if any, as discussed below.

Pitch Shifting Using the Sinusoidal Model

FIG. 10 demonstrates the need for appropriate phase compensation for pitch-shifting. Signal 1040 is a frame-by-frame pitch-shifted version of signal 1000 without phase compensation, which clearly lacks phase coherence between frames. Signal 1055 is pitch-shifted with the linear phase compensation described above, which preserves the phase coherence between frames.

To derive an algorithm for pitch shifting using the sinusoidal model, reference is again made to the model given in Eq. 19. Letting
φₖ^{m}(t)=(t−mT)ωₖ^{m}+θₖ^{m} (21)
account for the temporal evolution of each sinusoidal component phase in frame m, Eq. 19 becomes

$$s ( t ) = {\sum }_{k = 1}^{K ( m )} {A}_{k}^{m} exp \{ j {φ}_{k}^{n} ( t ) \} \qquad ( 22 )$$

If it is desired to multiply the pitch of this waveform by the pitch-scaling factor ρ 210, then the first step is to effectively re-sample the waveform. If \tilde{s}(t) represents the pitch-shifted model, then

$$\tilde{s} ( t ) = s ( ρ t ) = {\sum }_{k = 1}^{K ( m )} {A}_{k}^{m} exp \{ j {φ}_{k}^{m} ( ρ t ) \} \qquad ( 23 )$$

where the range of each frame m is now given by
(m−1)\tilde{T}≦t≦(m+1)\tilde{T}. (24)
Correspondingly, the length of each frame becomes

$$\tilde{T} = \frac{T}{ρ} . \qquad ( 25 )$$

As shown in FIG. 10, each frame of the original model of length T 1005 becomes a frame of the pitch-scaled model of length \tilde{T} 1045 of the pitch-modified signal 1040. Substituting Eq. 21 in Eq. 23 leads to the pitch-scaled version of the model of Eq. 19,

$$\tilde{s} ( t ) = {\sum }_{k = 1}^{K ( m )} {A}_{k}^{m} exp \{ j [ ( t - m \tilde{T} ) {ρω}_{k}^{m} + {θ}_{k}^{m} ] \} , \qquad ( 26 )$$

which shows that the model frequencies have indeed been scaled by ρ. It is important to note that the phase values that were originally measured at the centers of frames of length T have been implicitly moved to the centers of frames of length \tilde{T}. The effect of this shift is to maintain the phase coherence and the voicing properties that are implicit in the measured phases. In doing so, however, the time scale has been compressed or expanded. Furthermore, since the sinusoidal component amplitudes are now associated with the scaled frequencies, the vocal tract shape has been altered. The second problem is addressed in the following section on voice timbre modification. The first problem is solved by time-scaling the model back to the original time scale as follows.

The time-scaling algorithm can be applied to the pitch-shifted waveform in order to restore the waveform back to the original time scale. Since the frequencies of the pitch-scaled waveform were scaled by the factor ρ, then if Ω₀^{m} represents the fundamental frequency of the original waveform in analysis frame m, the corresponding shifted fundamental will be
\tilde{106}₀^{m}=ρΩ₀^{m}. (27 )
In addition, the length of the original frame, T, will compressed (or expanded) to the frame length \tilde{T}, as specified in Eq. 25. In this case, the phase compensation and onset time estimation unit 425 estimates the fundamental phase \tilde{θ}₀^{m} 435 of the pitch-shifted waveform using Eq. 10 as
\tilde{θ}₀^{m}=\tilde{θ}₀^{m-1}+ρ(Ω₀^{m-1}+Ω₀^{m})\tilde{T}/2, (28)
and the onset time ñ₀^{m} 505 of the pitch-shifted waveform on the altered time scale as
ñ₀^{m}=−\tilde{θ}₀^{m}/ρΩ₀^{m}. (29)
If the time scale of pitch-shifted waveform is to be expanded (or compressed) to the original time scale of the input waveform, the appropriate time-scale compensation factor is simply
β=ρ. (30)

By Eqs. 12 and 30, the frame length \hat{T} of the pitch-scaled and time-scale compensated signal 1055 then becomes

$$\hat{T} = β \tilde{T} = β ( \frac{T}{ρ} ) = T , \qquad ( 31 )$$

as shown in FIG. 10, at 1050.

Eq. 31 proves that pitch shifting can be performed without time scaling because the time scale of the pitch-shifted signal is equal to the time scale of the original signal. In this case, the pitch-scaled sinusoidal model becomes

$$\tilde{s} ( t ) = {\sum }_{k = 1}^{K ( m )} {A}_{k}^{m} exp \{ j [ ( t - mT ) {ρω}_{k}^{m} + {θ}_{k}^{m} + ( {n}_{0}^{m} - {\tilde{n}}_{0}^{m} ) {ρω}_{k}^{m} ] \} \qquad ( 32 )$$

This equation shows that pitch-scaling can be accomplished by scaling the measured frequencies and adding a linear phase compensation term that is proportional to the scaled pitch frequencies.
Pitch Shifting and Time Scaling the Waveform

Within the context of the sinusoidal model, the model can be generalized to allow for independent control of pitch scaling and time scaling by specifying an aggregate time-scaling factor 415
β′=ρ·α, (33)
where α 220 is the independently controlled time-scale factor. Substituting Eqs. 25 and 33 into Eq. 12, the new aggregate frame length becomes

$${T}^{′} = {β}^{′} \tilde{T} = ρα ( \frac{T}{ρ} ) = α T , \qquad ( 34 )$$

which proves the independence of time scaling and pitch scaling. The phase compensation and onset time estimator 425 now determines the fundamental phase of the pitch-scaled and time-scaled waveform as
θ′₀^{m=θ′}₀^{m-1}+ρ(Ω₀^{m-1}+Ω₀^{m})T′/2, (35)
with an associated onset time 505 (in reference to the new frame length T′) of
n′₀^{m}(α)=−θ′₀^{m}/ρΩ₀^{m}. (36)
Now, the sinusoidal representation of the pitch- and time-scaled waveform becomes

$${s}^{′} ( t ) = {\sum }_{k = 1}^{K ( m )} {A}_{k}^{m} exp \{ j [ ( t - m {T}^{′} ) ρ {ω}_{k}^{m} + {θ}_{k}^{′ m} ] \} , \qquad ( 37 )$$

where the resulting frame is defined over the interval
(m−1)T′≦t≦(m+1)T′, (38)
and the new component phases 435 are given by
θ′ₖ^{m}=θₖ^{m}+(ñ₀^{m}−n′₀^{m}(α))ρωₖ^{m}. (39)
(As a reminder, θₖ^{m} refer to the measured phases of the original waveform.) Substituting Eq. 39 into Eq. 37 the sinusoidal representation of the pitch-scaled, time-scaled waveform is then fully specified by the following equation:

$${s}^{′} ( t ) = {\sum }_{k = 1}^{K ( m )} {A}_{k}^{m} exp \{ j [ ( t - m {T}^{′} ) ρ {ω}_{k}^{m} + {θ}_{k}^{m} + ( {\tilde{n}}_{0}^{m} - {n}_{0}^{′ m} ( α ) ) ρ {ω}_{k}^{m} ] \} . \qquad ( 40 )$$

In other words, the pitch-scaled and time-scaled waveform is obtained by scaling the frequencies by the pitch-scaling factor and compensating for the phase effects of pitch-scaling and time-scaling with a linear phase term derived from the difference in onset times between the pitch-shifted and time-scaled waveforms. Of course, time-scaling can be performed without pitch-scaling simply by setting Eq. 40 to have ρ=1, resulting in Eq. 20 as expected. Note that the model allows for the pitch-scaling and time-scaling factors to be time varying.
Timbre Modification Using the Sinusoidal Model

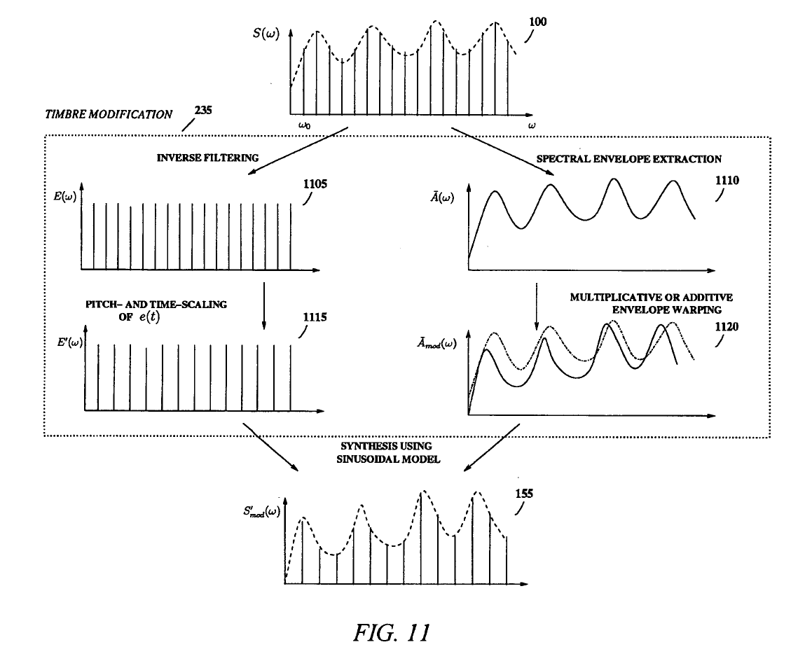

FIG. 11 shows steps involved in timbre modification using spectral envelope estimation and warping, according to one embodiment. The set of sinusoidal component amplitudes Aₖ^{m} measured at the frequencies ωₖ^{m} correspond to samples of the spectral envelope of the sound 100. The spectral envelope models the low-resolution frequency structure of the signal, i.e. the overall shape of the spectrum. The peaks in this envelope, called the formants, are critical for human listeners to correctly identify phonemes in the case of speech signals. The formant frequencies and bandwidths are direct results of the vocal tract shape of the speaker. Alteration of the spectral envelope will alter the timbre of the sound. When applied to speech, this type of timbre modification can result in the alteration of speaker identity, age, or gender.

The preferred embodiment estimates the overall spectral envelope based upon the estimation of peaks of the magnitude spectrum. The spectral envelope is then found by interpolating between the peaks using linear or spline interpolation. Alternate embodiments of spectral envelope estimation may utilize linear predictive modeling or homomorphic smoothing. For more information regarding spectral envelope estimation, Refer to D. B. Paul, “The Spectral Envelope Estimation Vocoder”, IEEE Trans. Acoust., Speech and Signal Proc., ASSP-29, 1981, pp.786-794, the entire contents of which are incorporated herein by reference.

If \overline{A}(ω) 1110 is the magnitude of the spectral envelope determined using one of the methods mentioned above, and assuming that this envelope is a good model of the magnitude of the transfer function, the corresponding phase response, Φ(ω)), can also be determined by constraining the transfer function. In the preferred embodiment, the transfer function is assumed to be minimum phase, hence, the phase response is determined as the Hilbert transform of log\overline{A}(ω). Alternative embodiments include constraining the effective area of the vocal tract. Once the amplitude envelope and phase response are determined, the transfer function is completely characterized. A subsequent inverse filtering of the original signal yields the residual (or excitation) waveform 1105:

$$e ( t ) = {\sum }_{k = 1}^{K ( m )} {e}_{k}^{m} exp \{ j [ ( t - m T ) {ω}_{k}^{m} + {ɛ}_{k}^{m} ] \} \qquad ( 41 )$$

Here, the amplitudes of the residual's harmonics are obtained by removing the contribution of the magnitude response of the transfer function from Aₖ^{m}:
eₖ^{m}=Aₖ^{m}/\overline{A}(ωₖ^{m}) (42)
and the phases are obtained by subtracting the contribution of the phase of the transfer function from θₖ^{m}:
εₖ^{m}=θₖ^{m}−Φ(ωₖ^{m}) (43)
Note that the amplitude envelope of the residual, eₖ^{m}, will be very “flat”, as seen in FIG. 11.

The effects of the original spectral envelope (corresponding to the vocal tract filter in the case of speech signals) have now been removed from the waveform. If the speaker characteristics are to be altered in a controlled way, as is the goal of voice modification systems, it is desirable to modify the spectral envelope according to some rule and then apply the modified function to the excitation signal. Spectral envelope modification can be achieved by remapping the magnitude of the spectral envelope according to a warping function Ψ(·), i.e.
\overline{A}_{mod}(ω)=Ψ(A(ω)) (44)
The warping function is chosen such that it achieves the desired effect. In the preferred embodiment, the warping function consists of a scale factor and a frequency shift,
\overline{A}_{mod}(ω)=A(σω−ωₛ) (45)
where σ is the spectrum scaling factor (greater than one for compression of the spectrum and less than one for expansion) and ωₛ represents an additive frequency shift. In alternate embodiments, Ψ(·) may be non-linear. For example, the spectral scaling could be a function of frequency, so that the amount of scaling is frequency dependent, or a function of energy so that the amount of scaling is energy dependent.

Once the amplitude envelope is modified to give \overline{A}_{mod}(ω) 1120, it is necessary to determine the modified phase response, Φ_{mod}(ω) I using the minimum phase assumption. Application of the modified spectral envelope to the excitation function results in the following timbre-modified speech signal:

$${s}_{mod} ( t ) = {\sum }_{k = 1}^{K ( m )} {e}_{k}^{m} {\overline{A}}_{mod} ( {ω}_{k}^{m} ) exp \{ j [ ( t - m T ) {ω}_{k}^{m} + {ɛ}_{k}^{m} + {Φ}_{mod} ( {ω}_{k}^{m} ) ] \} \qquad ( 46 )$$

Timbre Modification with Time-Scaling and Pitch-Scaling

Previous sections have shown how the waveform can be pitch-scaled and time-scaled using the sinusoidal model. Pitch-scaling, however, alters the shape of the vocal tract response thus affecting the timbre of the speech. This alteration occurs because the measured sinusoidal component amplitudes, which were originally measured at the frequencies ωₖ^{m}, are now associated with the frequencies ρωₖ^{m}, which effectively changes the spectral envelope.

If the goal is exclusively time- and pitch-scaling (without timbre modification) this shift of formants is clearly undesirable. Hence, at the very least, the original vocal tract shape must be restored if the waveform is pitch-scaled. Additionally, it would be advantageous to have independent control of the vocal tract, so that timbre or speaker identity can be preserved or changed independently of the time-scaling or pitch-scaling process.

In the preferred embodiment, the original timbre is maintained by inverse filtering the original waveform, applying pitch-scaling or time-scaling to the residual signal, and subsequently applying the desired (original or modified) spectral envelope (FIG. 11). This procedure helps to isolate the vocal tract characteristics, and therefore modify them independently of the time-scaling or pitch-scaling process. It should be noted that the possibility of deriving a meaningful spectral envelope depends on how easily the excitation can be separated from the spectrum.

In order to preserve or independently modify the timbre, the pitch-scaling and time-scaling algorithms can be applied directly to the excitation waveform, e(t) 1105. After modifications are carried out, the original spectral envelope can be re-introduced, which would preserve the original formant structure. In this case, the expression for the intermediate pitch- or time-scaled residual waveform 1115 is given by

$${e}^{′} ( t ) = {\sum }_{k = 1}^{K ( m )} {e}_{k}^{m} exp \{ j [ ( t - m {T}^{′} ) ρ {ω}_{k}^{m} + {ɛ}_{k}^{m} + ( {\tilde{n}}_{0}^{m} - {n}_{0}^{′ m} ( α ) ) ρ {ω}_{k}^{m} ] \} \qquad ( 47 )$$

where the onset times are computed as stated in the Eqs. 29 and 36. The final pitch-scaled, time-scaled speech waveform with the original spectral envelope is written as

$${s}^{′} ( t ) = {\sum }_{k = 1}^{K ( m )} {e}_{k}^{m} \overline{A} ( ρ {ω}_{k}^{m} ) exp \{ j [ ( t - m {T}^{′} ) ρ {ω}_{k}^{m} + {ɛ}_{k}^{m} + ( {\tilde{n}}_{0}^{m} - {n}_{0}^{′ m} ( α ) ) ρ {ω}_{k}^{m} + Φ ( ρ {ω}_{k}^{m} ) ] \} \qquad ( 48 )$$

This model preserves the formant structure of the original speaker to the extent that the formant structure is well-modeled by the spectral envelope. Using an independently modified spectral envelope \overline{A}_{mod}(ω) as specified in Eq. 44, a sinusoidal model with independent control of time scaling, pitch scaling, and timbre modification is given by

$${s}_{mod}^{′} ( t ) = {\sum }_{k = 1}^{K ( m )} {e}_{k}^{m} {\overline{A}}_{mod} ( ρ {ω}_{k}^{m} ) exp \{ j [ ( t - m {T}^{′} ) ρ {ω}_{k}^{m} + {ɛ}_{k}^{m} + ( {\tilde{n}}_{0}^{m} - {n}_{0}^{′ m} ( α ) ) ρ {ω}_{k}^{m} + {Φ}_{mod} ( ρ {ω}_{k}^{m} ) ] \} \qquad ( 49 )$$

FIG. 11 illustrates the full acoustic modification process in the frequency domain. From the magnitude spectrum of the input signal model S(ω) 100, the spectral envelope \overline{A}(ω) 1110 is estimated and used to calculate the excitation signal whose spectrum is E(ω) 1105. This excitation signal is pitch-scaled and time-scaled, resulting in the modified spectrum E′(ω) 1115, and the spectral envelope is modified to \overline{A}_{mod}(ω) 1120. The modified spectral envelope is then applied to the pitch-scaled and time-scaled excitation resulting in S′_{mod}(ω), the frequency domain representation of the modified signal s′_{mod}(t) 155.

Application to Coding and Compression

The sinusoidal model described herein can also be used to code or compress acoustic signals, particularly speech and music signals. In coding or compression applications, the sinusoidal model parameters are quantized, encoded, and packed into a bit stream. The bit stream can be decoded by unpacking, decoding, and unquantizing the parameters.

The pitch-scaling system described herein can be applied to efficiently encode the pitch in sinusoidal models. In typical sinusoidal coders, the pitch and phases are quantized independently. This requires that the pitch quantization error be very small in order to maintain phase coherence which may require an excessive number of bits. However, in the preferred embodiment, the phase coherence is maintained by pitch shifting by an amount corresponding to the pitch quantization error. This process will maintain phase coherence and allow for the use of fewer bits for quantizing the pitch.

Those of ordinary skill in the art realize that methods involved in a system and method for modification of acoustic signals using sinusoidal analysis and synthesis may be embodied in a computer program product that includes a computer-usable medium. For example, such a computer usable medium can include a readable memory device, such as a hard drive device, a CD-ROM, a DVD-ROM, a computer diskette or solid-state memory components (ROM, RAM), having computer readable program code segments stored thereon. The computer readable medium can also include a communications or transmission medium, such as a bus or a communications link, either optical, wired, or wireless, having program code segments carried thereon as digital or analog data signals.

While this invention has been particularly shown and described with references to preferred embodiments thereof, it will be understood by those skilled in the art that various changes in form and details may be made therein without departing from the scope of the invention encompassed by the appended claims.

1. A method of modifying an acoustic waveform, comprising:
sampling an original waveform to obtain a series of discrete samples and constructing therefrom a series of frames, each frame spanning a plurality of samples;
analyzing each frame of samples to obtain a set of components having individual amplitudes, frequencies, and phases which, in summation, approximate the waveform of the frame, the set of components being characterized by a fundamental frequency;
modifying the individual frequencies of the set of components by a pitch-scaling factor, resulting in a set of modified components having individual pitch scaled frequencies that are characterized by a pitch-scaled fundamental frequency;
for each of the individual phases of the set of modified components, adding a phase compensation term that depends on the fundamental frequency and the pitch-scaled fundamental frequency, the phase compensation term enabling a synthesized pitch-scaled waveform to be generated having frames sizes that are substantially equal to the frame sizes of the original waveform and having phase coherence across frame boundaries.

2. The method of claim 1 further comprising:
generating the synthesized pitch-scaled waveform from the set of modified components for each frame.

3. The method of claim 1 wherein the phase compensation term is a linear term that is proportional to the pitch scaled frequencies.

4. The method of claim 3 wherein the proportion depends on a difference between a first onset time associated with the original waveform and a second onset time associated with the pitch-scaled synthesized waveform.

5. The method of claim 1 further comprises:
independently modifying a frame size of a synthesis frame containing the set of modified components by a time-scaling factor; and
the phase compensation term being further dependent on the time-scaling factor, the phase compensation term enabling a synthesized pitch-scaled and time-scaled waveform to be generated having frame sizes that differ from the frame sizes of the original waveform and having phase coherence across frame boundaries.

6. The method of claim 5 wherein phase compensation term is a linear phase term that is proportional to the pitch scaled frequencies, the proportion depending on a difference in a first onset time associated with the pitch-scaling factor and a second onset time associated with the time-scaling factor.

7. The method of claim 1 further comprising:
independently modifying the individual amplitudes and phases of the set of modified components to warp the spectral envelope of the waveform, enabling a synthesized pitch-scaled and timbre-modified waveform to be generated.

8. The method of claim 1 wherein the pitch-scaling factor is continuously variable over a defined range.

9. The method of claim 5 wherein the time-scaling factor is continuously variable over a defined range.

10. The method of claim 7 wherein warping the spectral envelope of the waveform comprises:
estimating an amplitude of the spectral envelope;
applying a linear or nonlinear mapping from the estimated spectral envelope amplitude to the warped spectral envelope; and
estimating the phase of the spectral envelope using a minimum phase assumption.

11. The method of claim 1 wherein analyzing each frame of samples to obtain a set of components having individual amplitudes, frequencies, and phases includes peak picking.

12. The method of claim 1 wherein the set of components from each frame of the original waveform or the set of modified components are coded or compressed prior to generation of the synthesized waveform.

13. The method of claim 1 wherein the set of components from each frame of the original waveform or the set of modified components are decoded or decompressed prior to generation of the synthesized waveform.

14. The method of claim 1 wherein the individual frequencies of the set of components are modified by a pitch scaling factor to compensate for quantization errors introduced by pitch quantization.

15. The method of claim 1 wherein adding a phase compensation term to the phase of each component comprises computing an onset time from an estimated fundamental frequency and phase.

16. The method of claim 1 wherein adding a phase compensation term to the phase of each component comprises computing an onset time from an estimate of a fundamental pitch period and establishing a temporal sequence of onset times therefrom.

17. The method of claim 1 wherein the set of components includes any set of sinusoidal functions with finite support in the time domain or any set of sinusoidal functions with infinite support in the time domain.

18. A method of modifying an acoustic waveform, comprising:
providing a set of components having individual amplitudes, frequencies, and phases which, in summation, approximate a frame of an acoustic waveform, the set of components being characterized by a fundamental frequency;
modifying the individual frequencies of the set of components by a pitch scaling factor, resulting in a set of modified components having individual pitch-scaled frequencies that are characterized by a pitch-scaled fundamental frequency;
for each of the individual phases of the set of modified components, adding a phase compensation term that depends on the fundamental frequency and the pitch-scaled fundamental frequency, the phase compensation term enabling a synthesized pitch-scaled waveform to be generated having frame sizes that are substantially equal to the frame sizes of the original waveform and having phase coherence across frame boundaries.

19. The method of claim 18 further comprises:
independently modifying a frame size of a synthesis frame containing the set of modified components by a time-scaling factor; and
the phase compensation term being further dependent on the time-scaling factor, the phase compensation term enabling a synthesized pitch-scaled and time-scaled waveform to be generated having frame sizes that differ from the frame sizes of the original waveform and having phase coherence across frame boundaries.

20. The method of claim 18 further comprising:
independently modifying the individual amplitudes and phases of the set of modified components to warp the spectral envelope of the waveform, enabling a synthesized pitch-scaled and timbre-modified waveform to be generated.

21. A system of modifying an acoustic waveform, comprising:
an analyzer sampling an original waveform to obtain a series of discrete samples and constructing therefrom a series of frames, each frame spanning a plurality of samples;
the analyzer analyzing each frame of samples to obtain a set of components having individual amplitudes, frequencies, and phases which, in summation, approximate the waveform of the frame, the set of components being characterized by a fundamental frequency;
a frequency-scaler modifying the individual frequencies of the set of components by a pitch-scaling factor, resulting in a set of modified components having individual pitch-scaled frequencies that are characterized by a pitch-scaled fundamental frequency;
a phase compensator, for each of the individual phases of the set of modified components, the phase compensator adding a phase compensation term that depends on the fundamental frequency and the pitch-scaled fundamental frequency, the phase compensation term enabling a synthesized pitch-scaled waveform to be generated having frames sizes that are substantially equal to the frame sizes of the original waveform and having phase coherence across frame boundaries.

22. The system of claim 21 further comprising:
a synthesizer generating the synthesized pitch-scaled waveform from the set of modified components for each frame.

23. The system of claim 21 further comprises:
a time-scaler independently modifying a frame size of a synthesis frame containing the set of modified components by a time-scaling factor; and
the phase compensation term added by the phase compensator being further dependent on the time-scaling factor, the phase compensation term enabling a synthesized pitch-scaled and time-scaled waveform to be generated having frame sizes that differ from the frame sizes of the original waveform and having phase coherence across frame boundaries.

24. The system of claim 21 further comprising:
a timbre modifier independently modifying the individual amplitudes and phases of the set of modified components to warp the spectral envelope of the waveform, enabling a synthesized pitch-scaled and timbre-modified waveform to be generated.

25. A system of modifying an acoustic waveform, comprising:
means for providing a set of components having individual amplitudes, frequencies, and phases which, in summation, approximate a frame of an acoustic waveform, the set of components being characterized by a fundamental frequency;
means for modifying the individual frequencies of the set of components by a pitch scaling factor, resulting in a set of modified components having individual pitch-scaled frequencies that are characterized by a pitch-scaled fundamental frequency;
for each of the individual phases of the set of modified components, means for adding a phase compensation term that depends on the fundamental frequency and the pitch-scaled fundamental frequency, the phase compensation term enabling a synthesized pitch-scaled waveform to be generated having frame sizes that are substantially equal to the frame sizes of the original waveform and having phase coherence across frame boundaries.

26. The system of claim 25 further comprises:
means for independently modifying a frame size of a synthesis frame containing the set of modified components by a time-scaling factor; and
the phase compensation term being further dependent on the time-scaling factor, the phase compensation term enabling a synthesized pitch-scaled and time-scaled waveform to be generated having frame sizes that differ from the frame sizes of the original waveform and having phase coherence across frame boundaries.

27. The system of claim 25 further comprising:
means for independently modifying the individual amplitudes and phases of the set of modified components to warp the spectral envelope of the waveform, enabling a synthesized pitch-scaled and timbre-modified waveform to be generated.
